(19) United States
(12) Patent Application Publication
(10) Pub. No.: US 2014/0208925 A1
(43) Pub. Date: Jul. 31, 2014

(54) PICKUP SYSTEM FOR CAJON PERCUSSION INSTRUMENTS

(71) Applicant: Gary Thomas Osborne, Indianapolis, IN (US)

(72) Inventor: Gary Thomas Osborne, Indianapolis, IN (US)

(21) Appl. No.: 14/166,542

(22) Filed: Jan. 28, 2014

Related U.S. Application Data
(60) Provisional application No. 61/758,398, filed on Jan. 30, 2013.

(51) Int. Cl. G10H 3/14

(52) U.S. Cl. CPC G10H 3/14; G10H 3/143
USPC 84/725; 84/723; 84/730

(57) ABSTRACT

A pickup system for a cajón percussion instrument that includes pickups coupled to the cajón that provide pickup signals to a control box that provides a system output signal. Pickups can be located on different or the same panels of the cajón. Pickups can be near one another to produce similar pickup signals. The system can include audio processors for modifying the pickup signals. The audio processors can include filters for changing amplitude verses frequency responses. The control box can include a summing device for combining the pickup signals. The system can include one or more output jacks. The pickup signals can be provided to different output jacks. The pickups can include piezoelectric pickups, microphones, coils and magnets, or other types of pickups. The control box can include tone and volume controls accessible and adjustable by a player to modify the system output signal.

This application claims priority to U.S. Provisional Patent Application Ser. No. 61/758,398, filed Jan. 30, 2013 entitled “Portable Pickup System for Cajon Percussion Instrument,” the disclosure of which is expressly incorporated herein by reference.

### BACKGROUND AND SUMMARY

The present invention generally relates to musical instrument pickups, and more specifically to a pickup system for a cajón percussion instrument.

A cajón percussion instrument typically has a hollow box-like structure with flat panels of wood, plastic, fiberglass, fiber board or other materials. Cajóns of different shapes, sizes, and colors are commercially available. The front, back and side panels are typically oriented vertically with respect to the top panel but slanted panels are not uncommon. Panels are joined at right angles but they may also be joined by bevels, curves, acute angles, or obtuse angles. The interior of the cajón forms a resonant cavity. The cajón may have one or more holes, ports, or vents. The panels and the vents influence the resonance of the cavity. There are usually internal snares or wires located against one or more panels of the cajón.

Typically, a person who plays the cajón sits on the top panel and slaps the front and side panels with their hands. When played, each panel vibrates to some extent and the vibratory motions of the panels displace air to produce sound. Air passes in an out of the vent. The cajón's characteristic sound can be attributed in part to its many vibrating panels, vent, and resonant cavity.

It would be desirable to provide a pickup system for a cajón percussion instrument that produces a system output signal with improved sound quality. It would also be desirable to enable longer playing time of the cajón with less interruption due to player discomfort or fatigue. It would be desirable to provide a pickup system for the interior of the cajón or flush mounted to the exterior surface of the panels of the cajón where it is less likely to be damage during transport. It would also be desirable to provide a circuit topology that enables the cajón pickup system designer greater flexibility to improve or enhance the sound quality of the system output signal. It would also be desirable to enable the system designer to incorporate one or more audio signal processors to modify the system output signal. It would also be desirable to enable the system designer to provide player-adjustable controls for the cajón player so that the player can readily adjust the tone quality or the character of the system output signal. It would also be desirable to provide a stereo system output signal from the cajón responsive to the cajón being slapped. It would also be desirable to place the sound produced by at least one of the panels in the center of a stereo image of the stereo, system output signal. Different embodiment disclosed herein may provide one or more of the above features.

A cajón percussion instrument is disclosed that includes a plurality of panels joined together to form an interior cavity, a plurality of pickups located in the interior cavity on at least three of the panels, and a control box. Each of the plurality of pickups produces a pickup output signal, and the control box combines the pickup output signals to provide a system output signal. At least one of the panels can be flat. At least two of the panels can be joined at a right angle. Each of the pickups can be located on a different panel. The pickups can include one or more piezoelectric pickups with a solid piezoelectric material to produce the pickup output signal; microphone pickups with a microphone to produce the pickup output signal; coil pickups with a coil of wire and a permanent magnet to produce the pickup output signal; or other types of pickups. The control box can include a tone control accessible and adjustable by a person playing the cajón percussion instrument to modify the system output signal. The cajón percussion instrument can also include one or more output jacks for the system output signal.

A pickup system is disclosed for a cajón percussion instrument that has a plurality of panels joined together to form an interior cavity. The pickup system includes first and second piezoelectric pickups coupled to the cajón percussion instrument, and a control box. The first and second piezoelectric pickups provide first and second pickup output signals respectively, and the control box provides a system output signal responsive to the cajón percussion instrument being slapped. The control box can combine the first and second pickup output signals to provide the system output signal. The first pickup can be located near the second pickup so that the first pickup output signal is similar to the second pickup output signal. The pickup system can also include a first audio signal processor for modifying the first pickup output signal and generating a processed first pickup output signal. The pickup system can also include a second audio signal processor for modifying the second pickup output signal and generating a processed second pickup output signal. The control box can also include a summing device for combining the processed first and second pickup output signals. The pickup system can also include left and right output jacks. The first piezoelectric pickup can provide the first pickup output signal for the left output jack, and the second piezoelectric pickup can provide the second pickup output signal for the right output jack.

A pickup system for a cajón percussion instrument is disclosed that includes a piezoelectric pickup providing a piezoelectric pickup output signal, a control box including an audio processor for modifying the piezoelectric pickup output signal and providing a system output signal, and an output jack for providing the system output signal for an external amplifier. The audio processor can include a filter for changing the amplitude verses frequency response of the system output signal. The filter can include at least one of a scooping filter and a resonant filter. The pickup system can also include a second pickup for providing a second pickup output signal. The control box can include a summing device for combining the piezoelectric pickup output signal with the second pickup output signal to provide the system output signal.

For a more complete understanding of the present disclosure, reference is now made to the following detailed description and the accompanying drawings.

### BRIEF DESCRIPTION OF THE DRAWINGS

FIG. 1 is a rear view of an exemplary cajón musical instrument with the back panel removed that includes an exemplary pickup system;

FIG. 2 is a side view of a cajón showing an exemplary left panel;

FIG. 3 is a schematic diagram of an exemplary control box for a pickup system;

FIG. 4 is a schematic diagram of an exemplary active control box for a pickup system;

FIG. 5 is a schematic diagram of an exemplary stereo control box for a pickup system;

FIG. 6 is a side view of an exemplary piezoelectric pickup that can be used in a pickup system;

FIG. 7 is a perspective view of an exemplary condenser microphone that can be used in a pickup system;

FIG. 8 is an exemplary amplitude verses frequency response curve of a scooping filter for an audio processor that can be used in a pickup system;

FIG. 9 is an exemplary amplitude verses frequency response curve of a resonant filter for an audio processor that can be used in a pickup system;

FIG. 10 is a schematic diagram of an exemplary signal processor with player-adjustable controls for enabling a cajón player to adjust the volume and the tone of the system output signal of an exemplary pickup system; and

FIG. 11 is a left side view of a cajón showing an exemplary cajón panel with a recessed cavity to protect player-adjustable controls and a system output phone jack of an exemplary pickup system.

FIG. 12 is a cross-section view A-A of the exemplary cajón of FIG. 11.

### DESCRIPTION OF PREFERRED EMBODIMENTS

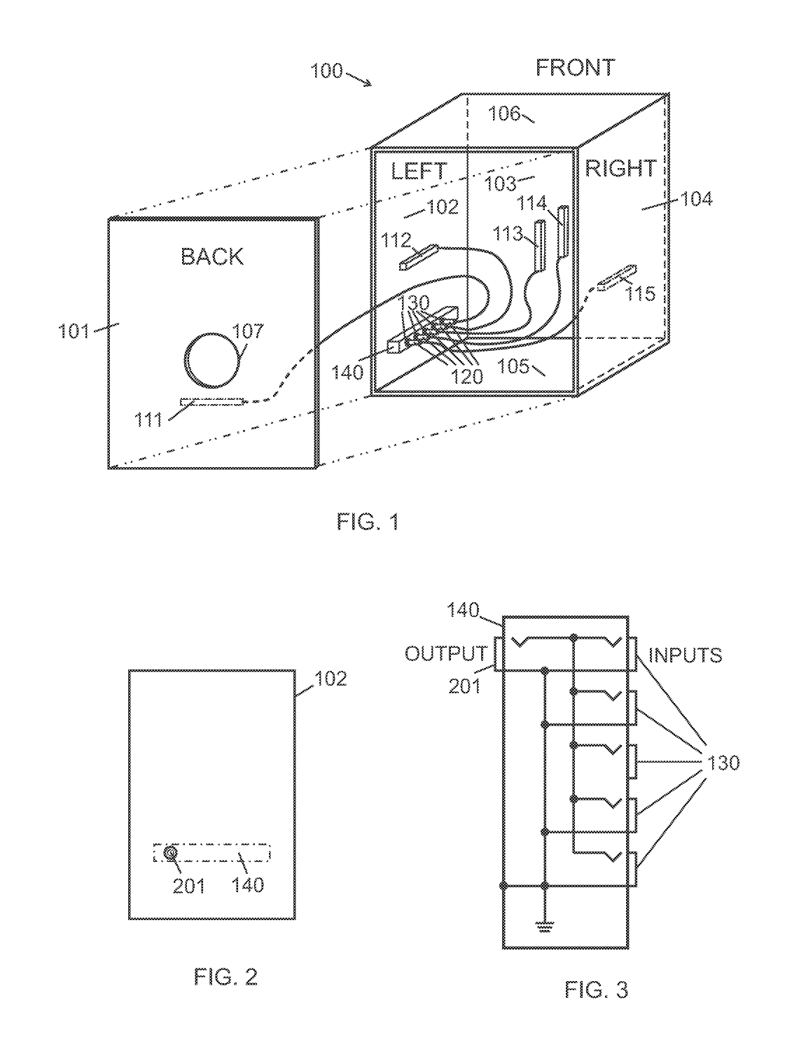

FIG. 1 is a rear view of an exemplary embodiment of a cajón 100 with a back panel 101 removed. The cajón 100 includes the back panel 101, a left side panel 102, a front panel 103, a right side panel 104, a bottom panel 105, a top panel 106, and a vent 107 in the back panel 101. The cajón 100 also includes five piezoelectric pickups 111, 112, 113, 114, 115 affixed to the inside surfaces of the panels 101, 102, 103, 103, 104 respectively for converting the vibratory motions of the back, side, and front panels 101, 102, 103, 104 into five pickup output signals. Each of the pickups 111, 112, 113, 114, 115 is subjected to different vibratory motions that depend in part on the cajón's construction and the pickup's location.

With the exception of the pickups 113, 114, each of the other pickup output signals is somewhat unique with respect to phase, amplitude, time delay, and/or frequency spectrum due to the unique vibratory motions that each pickup is subjected to. The pickup output signals of the pickups 113, 114 are more closely related because both of these pickups are located on the front panel 103 in close proximity to each other. The pickups 113, 114 are typically located near the center of the front panel 103, given that braces or design objectives may prohibit the pickups from being located exactly in the center. Low frequency vibrations of the front panel 103 are typically greater in this central area and result in greater bass-frequency content in the audio program of the pickup output signals of the pickups 113, 114.

The cajón 100 also includes a control box 140 which has five input jacks 130. There are five plugs 120 of the pickups 111-115 that are connected to the five input jacks 130.

FIG. 2 is a side view of the exemplary cajón 100 showing the control box 140 with a system output jack 201 that can be a system output ¼″ phone jack. The jack 201 can be connected via a shielded cable to an external preamplifier, optional dynamic range compressor, optional tone control, power amplifier, and/or speakers.

FIG. 3 is an exemplary schematic diagram of the control box 140 showing that this control box 140 combines the five pickup output signals received on the five input jacks 130 to produce a system output signal for the output jack 201. Given that the output signals of the pickups 113,114 are similar, especially at bass frequencies below 500 Hz, combining the pickup output signals further reinforces the bass response to make the output jack 201 system output signal more responsive to bass-frequency vibrations of the front panel 103 relative to vibrations of the other panels 101, 102, 104.

The system output signal can be modified by an external dynamic range compressor and tone control before it is passed to a power amplifier and speaker. The tone control can scoop-out the midrange frequencies of the system output signal. The compressor can be optionally switched on or off. When switched on, the compressor can reduce the dynamic range of the system output signal.

Better sound quality is produced because the system output signal represents vibrations from the multiple panels 101, 102, 103, 104. The mixing of the panel vibrations via the pickup output signals adds subjectively greater depth and complexity to the system output signal's sonic character. Listeners may judge the result to be better sound quality. This may be caused by the varied pickup output signals each contributing a different signal derived from the impulses of the player slapping the cajón 100.

It is believed that the variations in phase, amplitude, and time delay of the output signals of the pickups 111-115 creates varied, complex superposition in the resulting system output signal. Some of the frequencies are reinforced and others are cancelled by the superposition. Listening tests revealed that the more pickups, the better the sound because the complexity of the superposition increases with the number of pickups. The sound quality may be further improved by reinforcing the bass response via pickups 113, 114 and by the scooped frequency response curve of an external tone control.

To enable longer playing time, a player can activate an optional dynamic range compressor to increase the perceived sensitivity of the pickups 111-115. The greater sensitivity can enable the player to slap the panels of the cajón 100 with less force resulting in less fatigue and less discomfort.

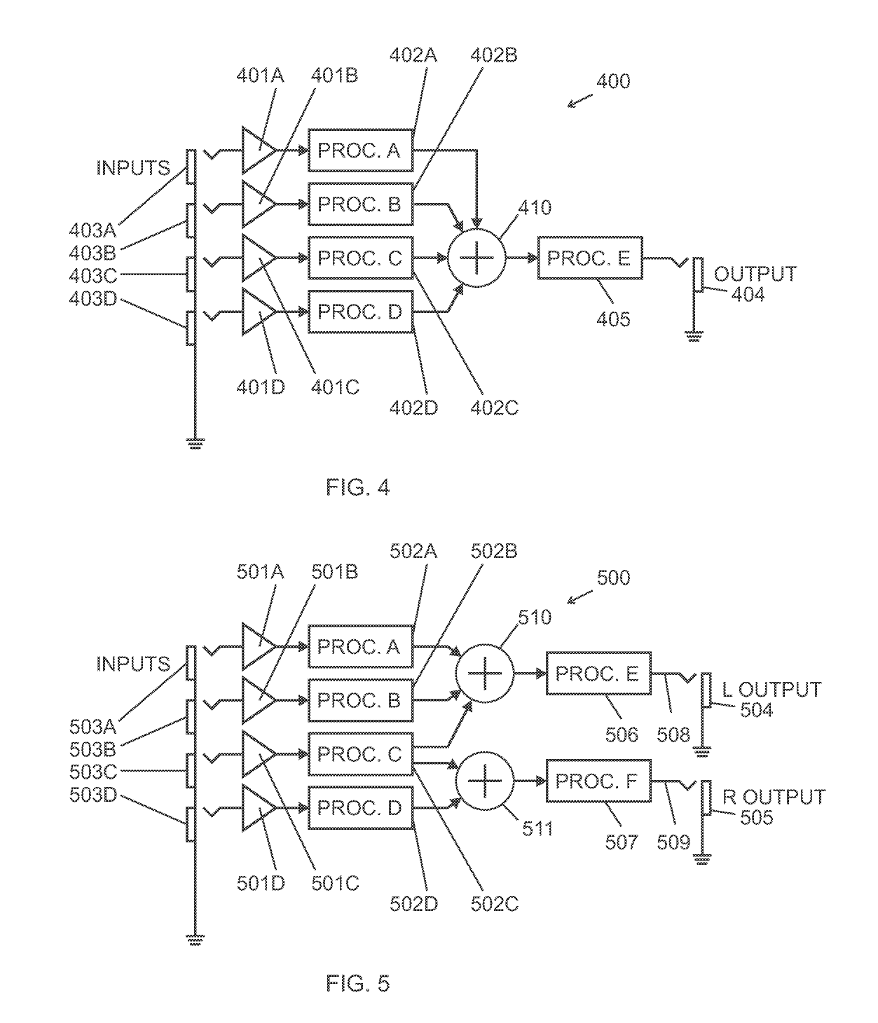

FIG. 4 is a schematic diagram of an exemplary active control box 400 which includes four input jacks 403A, 403B, 403C, 403D, an output jack 404, four preamplifiers 401A, 401B, 401C, 401D, four pickup signal audio processors 402A, 402B, 402C, 402D, and an overall audio processor 405. Each of the pickup output signals received at the four input jacks 403A, 403B, 403C, 403D is amplified and processed independently before being combined by a summing device 410. The combined signal is modified by the processor 405 to provide the system output signal for the output jack 404. The output jack 404 can be connected to an external power amplifier and speaker.

The pickups 111, 112, 113, 115 can be connected to the input jacks 403A, 403B, 403C, 403D respectively, and the pickup 114 can be deleted. To reinforce (increase) the bass response of the front panel 103, the third preamplifier 401C can have more gain than the other preamplifiers 401A, 401B, 401D. This gives greater gain to the vibrations of the front panel 103 via the pickup output signal of the pickup 113. The audio processor 402C can include a resonant filter to boost the gain of some low frequency content in the pickup output signal of the pickup 113. Each of the other audio processors 402A, 402B, 402D can be provided to modify the pickup output signals received from each of their respective pickups 111, 112, 115.

The control box 400 gives the system designer greater flexibility to improve, enhance, or modify the sound quality of the cajón 100 as it is represented in the system output signal. By way of examples, to achieve a desired sonic result, the designer may include circuits in the audio processors 402A-402D to filter the pickup output signals, EQ the signals, compress or expand the dynamic ranges of the signals, time delay the signals, shift the signals' phases, and/or clip the signals. The designer can choose to delete one or more of the audio processors and replace it with a direct connection to the summing device 410. The designer can combine two or more pickup signals to eliminate one or more audio processors.

The control box 400 also enables the designer to include player-adjustable controls for to the preamplifiers 401A-401D and the audio processors 402A-402D so that the player can adjust the system output signal sound quality as desired.

FIG. 5 is a schematic diagram of another exemplary stereo control box 500 that includes four input jacks 503A, 503B, 503C, 503D, a left output jack 504, a right output jack 505, four preamplifiers 501A, 501B, 501C, 501D, four pickup signal audio processors 502A, 502B, 502C, 502D, a left summing device 506 and a right summing device 507, and a left overall audio processor 506 and a right overall audio processor 507 to produce a left system output signal 508 and a right system output signal 509. The output jacks 504,505 can be connected to an external stereo power amplifier and stereo speakers. The output signal from the front panel pickup 113 is received at the input jack 503C, amplified by the preamplifier 501C, modified by the audio processor 502C and applied to both summing devices 506, 507. This puts the sound from the front panel 103 in the middle of the stereo image of the audio program comprising the left and right system output signals 508, 509.

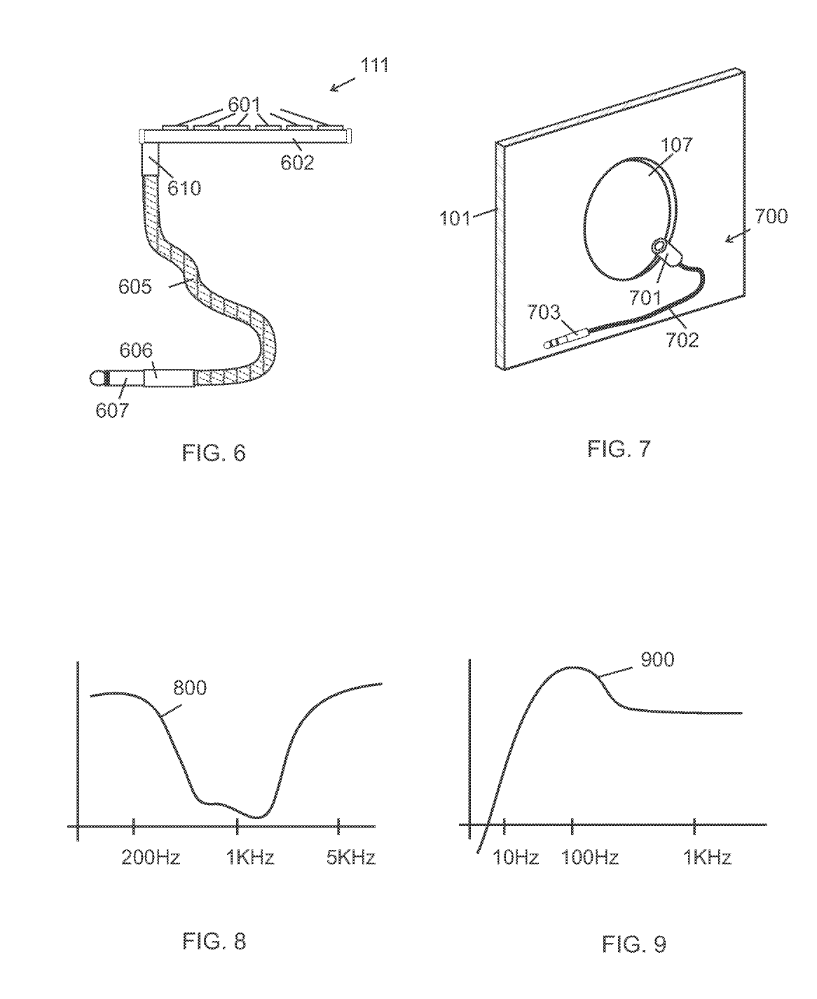

FIG. 6 is a side view of an exemplary piezoelectric pickup 111 which is the kind of pickup commonly installed under the bridge of an acoustic guitar. The piezoelectric pickup 111 has six piezo stones 601, a plastic tube outer case 602, a shielded cable 605, a miniature phone plug 607, and two plastic tube insulators 606, 610. The phone plug 607 can have a nominal diameter of 2.5 mm. This kind of piezoelectric pickup is chosen for its relative low cost and good availability from a number of manufacturers.

The pickup 111 can be affixed to the back panel 101 with an adhesive such as putty, glue, adhesive tape, or double-sided sticky tape. Or the pickup 111 can be attached by fasteners such as wood screws, wire ties, or clamps. Adhesives can be located between the stones 601 and the panel 101. The pickup 111 can be oriented on the panel 101 with the piezo stones 601 against the panel's surface. The other pickups 112-115 can have similar construction and likewise orientation on the other panels 102, 103, 104.

FIG. 7 is a perspective view of a condenser microphone 700, which can be used as a substitute for the pickup 111. The condenser microphone 700 includes a capsule 701 with a diaphragm that is responsive to air pressure changes to produce a microphone output signal, a shielded cable 702 for carrying the microphone output signal, and a miniature phone jack 703 also for carrying the microphone output signal. The microphone 700 can be located inside the cajón 100 near the vent 107 in the back panel 101 to make the microphone output signal responsive to the air movement in and out of the vent 107. The microphone 700 can be used instead of the pickup 111 and be plugged into the control box 400 or the control box 500. The control box 140 is not used with this embodiment because the different output impedances of the microphone 700 and the piezoelectric pickups 112-115 make the signals difficult to combine with a passive circuit. The first preamplifier 401 or 501 can be modified to provide phantom power for the microphone 700. (The phantom power may be deleted when the microphone 700 is an electret style.) The gain of the preamplifier can be changed to compensate for a difference between the microphone output signal amplitude of the microphone 700 and the pickup output signal amplitudes of the piezoelectric pickups 112-115. The audio processor that modifies the microphone output signal may also be modified to achieve a satisfactory sound quality depending on the placement and construction of the microphone.

FIG. 8 shows an exemplary amplitude verses frequency response curve 800 for a scooping filter in one or more of the audio processors. It shows that the scooping filter modifies the amplitude frequency response of an applied input signal. When the applied input signal is a sinusoid of varying frequency and constant peak-to-peak amplitude, the filter output signal has amplitude at 1000 Hertz that is less than the filter output signal amplitude at 200 Hertz. The filter output signal is also lower at 1000 Hertz than 5000 Hertz.

FIG. 9 shows an exemplary amplitude verses frequency response curve 900 for a resonant filter in one or more of the audio processors. When the applied input signal is a sinusoid of varying frequency and constant peak-to-peak amplitude, this filter modifies the signal so that the resulting output signal has greater amplitude at 100 Hertz than the amplitude at 10 Hertz or at 1000 Hertz.

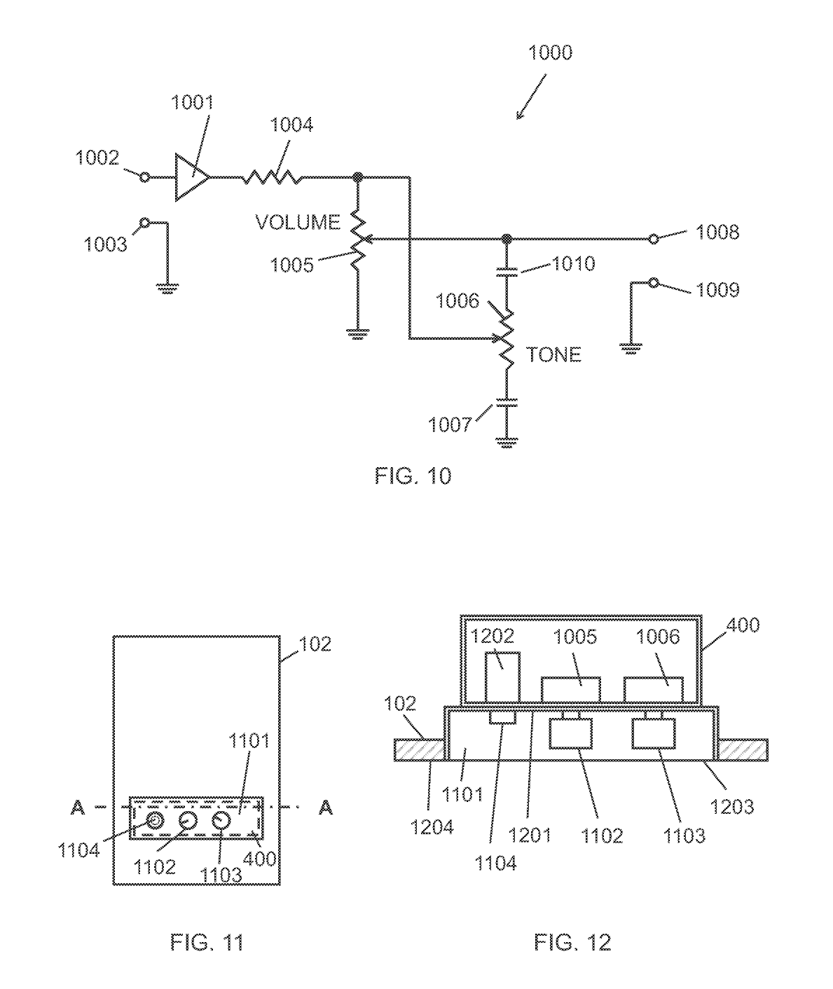

FIG. 10 is a schematic diagram of a signal processor 1000 with player-adjustable controls. The signal processor 1000 has input terminals 1002, 1003, a preamplifier 1001, a resistor 1004, a volume control potentiometer 1005, two capacitors 1007, 1010, a tone control potentiometer 1006, and output terminals 1008, 1009. In operation, the processor 1000 receives a pickup output signal at the input terminals 1002, 1003. The preamplifier 1001 amplifies the signal and provides it to the other components which adjust the volume and tone of the pickup output signal and then apply it to the output terminals 1008, 1009. Any of the audio signal processors of FIG. 4 or 5 can include this circuit.

FIG. 11 is an exemplary left side view of the cajón 100 showing the control box 400 with a system output phone jack 1104 which can be a system output ¼″ phone jack. The jack 1104 is connected to the output terminals 1008, 1009 and receives the system output signal from circuits within the control box 400. The jack 1104 can be connected via a shielded cable to an external amplifier.

The control box 400 has two control knobs 1102, 1103 which are connected to the volume control potentiometer 1005 and the tone control potentiometer 1006 respectively. The control knobs enable the cajón player to adjust the volume and tone of the system output signal.

FIG. 12 is a cross-section view A-A of the left side of the exemplary cajón 100. It shows the left side panel 102, the control box 400, a recessed cavity 1101, a recessed panel 1201 with the system output phone jack 1104 and the two control knobs 1102, 1103. Also shown are a phone jack body 1202 and the control potentiometers 1005, 1006.

The control box 400 can be located behind the recessed cavity 1101 in the left side panel 102. The recess 1101 can be deep enough so that the control knobs 1102, 1103 and the jack 1104 can be behind a plane 1203 defined by an outside surface 1204 of the panel 102. This arrangement protects the control knobs 1102, 1103 and the jack 1104 from accidental damage. If the cajón 100 is dropped on a floor on its side 102, the control knobs 1102, 1103 and the jack 1104 will not touch the floor due to the recess 1101.

### Other Embodiments

There are other pickup types known in the art of musical instruments. These include magnetic pickups that have a coil of wire and a permanent magnet, capacitive pickups, contact microphones, dynamic microphones, and condenser microphones. Any of these can be adapted to operate with a cajón provided that the preamplifiers are changed to compensate for differences in pickup output signal amplitudes. For operating in an environment of loud ambient noise, the pickup system designer can select to replace any microphone with a piezo pickup, which can be less susceptible to ambient noise and acoustic feedback.

The pickups can be installed at other locations on the panels of the cajon. Locating the pickups near the center makes the piezoelectric output signal have relatively greater low-frequency content than an identical pickup located near an edge or corner. The number of pickups can be increased or decreased to change the sonic character or the complexity of the superposition of the output signal produced. The pickups can be located on different panels of the cajón or they may be located on the same panel.

Piezoelectricity is an electric charge that accumulates in some solid materials (such as crystals, ceramics) in response to applied mechanical stress. The piezoelectric pickups utilize this property to convert vibrations into the pickup output signal. The piezoelectric pickup can be any shape or variety provided that it is subjected to mechanical stress or bending when the cajón is played, and produces the pickup output signal accordingly.

Any of the control boxes can have a recessed panel on the outside of the cajón. The output jack and user controls can be located on this panel where they may be better protected against accidental damage.

The type of output jack used for the system output signal is not limited by any theory of operation. The output jack can be a male 3-pin XLR connector type. A balanced line driver can be included in the control box to convert the single-ended system output signal to a balanced system output signal for the XLR output connector. Alternatively, a radio transmitter can be included in the control box to transmit the system output signal to a remote receiver which provides the system output signal for a power amplifier and speaker.

The control box can include a battery for providing power to the preamplifiers and processors. It can also be configured to receive and operate off of phantom power from a mixing console or power supply.

The pickup system is not limited by the shape, curvature, or carving of the panels of the cajón percussion instrument, nor is it limited by the method or hardware used to join the panels together.

While exemplary embodiments incorporating the principles of the present invention have been disclosed, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

I claim:

1. A cajón percussion instrument comprising:
a plurality of panels joined together to form an interior cavity;
a plurality of pickups located in the interior cavity on at least three of the panels, each of the plurality of pickups producing a pickup output signal; and
a control box combining the pickup output signals to provide a system output signal.

2. The cajón percussion instrument of claim 1, wherein at least one of the panels is flat.

3. The cajón percussion instrument of claim 1, wherein at least two of the panels are joined at a right angle.

4. The cajón percussion instrument of claim 1, wherein each of the plurality of pickups is located on a different panel.

5. The cajón percussion instrument of claim 1, wherein at least one of the plurality of pickups is a piezoelectric pickup having a solid piezoelectric material for generating the pickup output signal for the piezoelectric pickup.

6. The cajón percussion instrument of claim 1, wherein at least one of the plurality of pickups is a microphone pickup having a microphone for generating the pickup output signal for the microphone pickup.

7. The cajón percussion instrument of claim 1, wherein at least one of the plurality of pickups is a coil pickup having a coil of wire and a permanent magnet for generating the pickup output signal for the coil pickup.

8. The cajón percussion instrument of claim 1, wherein the control box further comprises a tone control accessible and adjustable by a person playing the cajón percussion instrument to modify the system output signal.

9. The cajón percussion instrument of claim 1, further comprising at least one output jack for the system output signal.

10. A pickup system for a cajón percussion instrument having a plurality of panels and an interior cavity, the pickup system comprising:
a first piezoelectric pickup coupled to the cajón percussion instrument and providing a first pickup output signal;
a second piezoelectric pickup coupled to the cajón percussion instrument and providing a second pickup output signal; and
a control box for providing a system output signal responsive to the cajón percussion instrument being slapped.

11. The pickup system of claim 10, wherein the control box combines the first pickup output signal with the second pickup output signal to provide the system output signal.

12. The pickup system of claim 10, wherein the first pickup is located near the second pickup so that the first pickup output signal is similar to the second pickup output signal.

13. The pickup system of claim 10, further comprising:
a first audio signal processor for modifying the first pickup output signal and generating a processed first pickup output signal; and
a second audio signal processor for modifying the second pickup output signal and generating a processed second pickup output signal.

14. The pickup system of claim 13, wherein the control box includes a summing device for combining the processed first pickup output signal with the processed second pickup output signal.

15. The pickup system of claim 10, further comprising a left output jack and a right output jack, the first piezoelectric pickup providing the first pickup output signal for the left output jack and the second piezoelectric pickup providing the second pickup output signal for the right output jack.

16. The pickup system of claim 10, wherein the first pickup and the second pickup are located inside the interior cavity.

17. A cajón percussion instrument having a pickup system comprising:
a piezoelectric pickup providing a piezoelectric pickup output signal;
a control box including an audio processor for modifying the piezoelectric pickup output signal and providing a system output signal; and
an output jack for providing the system output signal for an external amplifier.

18. The cajón percussion instrument of claim 17, wherein the audio processor includes a filter for changing the amplitude verses frequency response of the system output signal.

19. The cajón percussion instrument of claim 18, wherein the filter includes at least one of a scooping filter and a resonant filter.

20. The cajón percussion instrument of claim 17, further comprising a second pickup for providing a second pickup output signal.

21. The cajón percussion instrument of claim 20, wherein the control box includes a summing device for combining the piezoelectric pickup output signal with the second pickup output signal to provide the system output signal.

22. The cajón percussion instrument of claim 20, wherein the control box has at least one control knob located inside a recessed cavity to protect the control knob from damage, the control knob being accessible by a player for adjusting the system output signal.
